(19) United States
(12) Patent Application Publication
(10) Pub. No.: US 2010/0139066 A1
(43) Pub. Date: Jun. 10, 2010

(54) RIVETING TOOL WITH A RIVET ROD EXPELLING FUNCTION

(75) Inventor: Hsin-Chi Chen, Taiping City (TW)

Correspondence Address: PAI PATENT & TRADEMARK LAW FIRM, 1001 FOURTH AVENUE, SUITE 3200, SEATTLE, WA, 98154, US

(73) Assignee: TRANMAX MACHINERY CO., LTD., Taiping City (TW)

(21) Appl. No.: 12/631,856

(22) Filed: Dec. 6, 2009

(30) Foreign Application Priority Data
Dec. 9, 2008 (TW) 097147904

(51) Int. Cl. B23P 11/00

(52) U.S. Cl. 29/243.53

(57) ABSTRACT

A riveting tool with a rivet rod expelling function is disclosed to include a tool body having a base and a grip extended from the base. The base has a rivet passage defined therein and an opening located on the peripheral wall thereof in communication with the passage and adjacent to the grip for quick discharge of each broken rivet rod during the riveting operation.

### BACKGROUND OF THE INVENTION

1. Field of the Invention

The present invention relates to riveting tools and more particularly to a riveting tool with a rivet rod expelling function.

2. Description of the Related Art

When operating a riveting tool, a rivet is inserted into the rivet inlet of the riveting tool, and then the internal riveting mechanism of the riveting tool is operated to pull apart the inserted rivet, forcing the rivet head to fasten workpieces. When the rivet rod is pulled apart from the rivet had, it is left inside the rivet inlet. At this time, the user must turn the riveting tool to bias the rivet hole downwards for enabling the broken rivet rod to fall or to be shaken out of the rivet inlet so that a next riveting operation can be performed.

There is known another design of riveting tool, which has an internal center hole extending through the tool body. The broken rivet rod can be guided by the internal center hole out of the rear side of the tool body. However, an external force must be applied to the riveting tool to force the broken rivet rod to move toward the rear side of the tool body after each riveting operation. Further, this structure of riveting tool has the disadvantages of complicated structure and short working life. Further, when using this structure of riveting tool, the user may have to lift the rivet inlet and shake the tool body for causing the broken rivet rod to fall through the internal center hole to the outside of the tool body.

As stated above, the conventional riveting tools use an inconvenient method to expel broken rivet rods, interrupting the riveting operation, prolonging the working time and increasing trouble during the use of the riveting tool.

### SUMMARY OF THE INVENTION

The present invention has been accomplished under the circumstances in view. It is the main object of the present invention to provide a riveting tool, which facilitates the user to expel each broken rivet rod during the riveting operation.

To achieve this and other objects of the present invention, a riveting tool comprises a tool body having a base and a grip extended from the base. The base has a rivet passage defined therein and an opening located on the peripheral wall thereof in communication with the passage and adjacent to the grip for quick discharge of each broken rivet rod during the riveting operation. Based on this structural design, the user can expel each broken rivet rod conveniently during the riveting operation.

### BRIEF DESCRIPTION OF THE DRAWINGS

FIG. 1 is a schematic structural view of a first embodiment of the present invention, showing an opening located on the peripheral wall of the base of the riveting tool.

FIG. 2 is a schematic plain view, partially in section, of the first embodiment of the present invention, showing a rivet inserted into the rivet inlet.

FIG. 3 is a schematic plain view, partially in section, of the first embodiment of the present invention, showing the riveting mechanism pulled apart the rivet rod of the inserted rivet and moved the broken rivet rod into the passage.

FIG. 4 is a schematic plain view, partially in section, of the first embodiment of the present invention, showing the broken rivet rod moved to the opening.

FIG. 5 is a schematic structural view of a second embodiment of the present invention, showing a rivet rod collector pivotally connectable to the inside of the opening of the base.

FIG. 6 is a schematic structural view of the second embodiment of the present invention, showing the rivet rod collector in the second position.

FIG. 7 is a schematic structural view of a third embodiment of the present invention, showing a rivet rod collector transversely straightly insertable into the opening of the base.

FIG. 8 is a schematic structural view of a fourth embodiment of the present invention, showing a cover plate movably mounted in the opening of the base.

FIG. 9 is an elevational view, showing the rivet rod collector case provided with a stop plate according to the second embodiment of the present invention.

FIG. 10 is a schematic structural view of a fifth embodiment of the present invention, showing a rivet rod collection bag attached to the opening of the base.

### DETAILED DESCRIPTION OF THE INVENTION

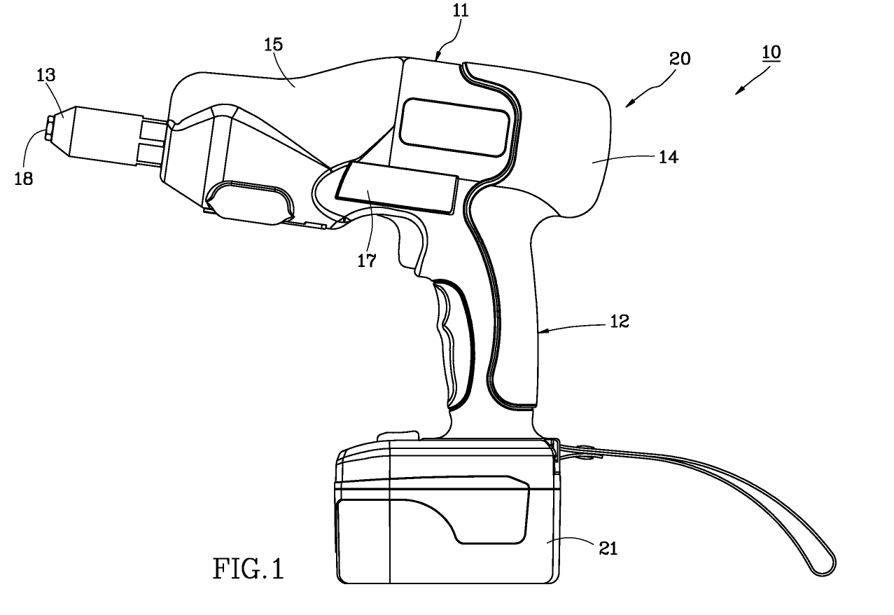

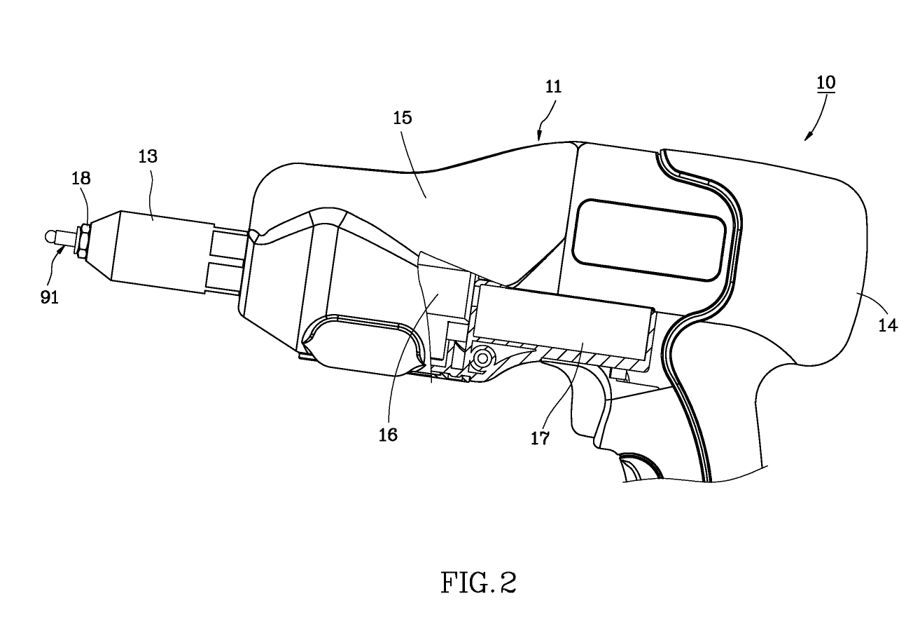

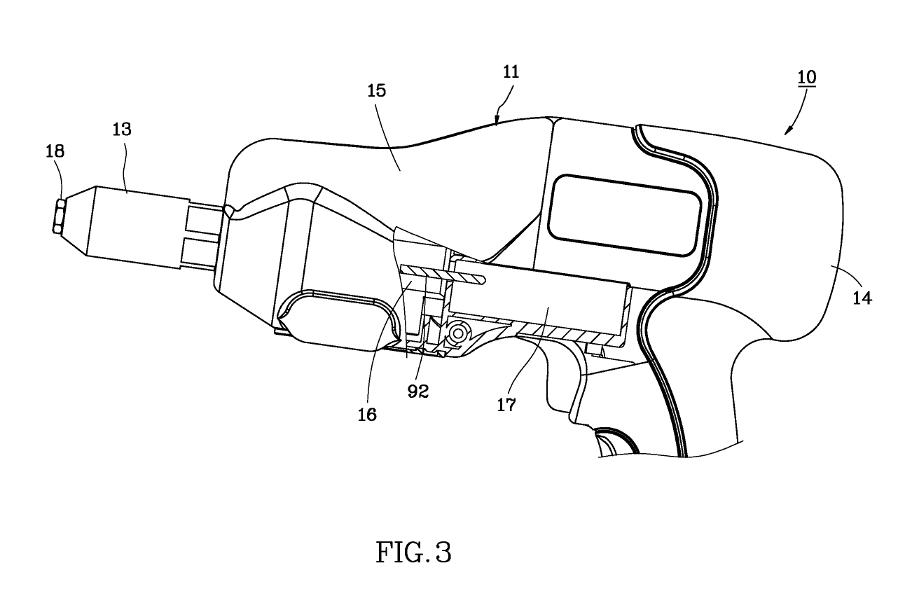

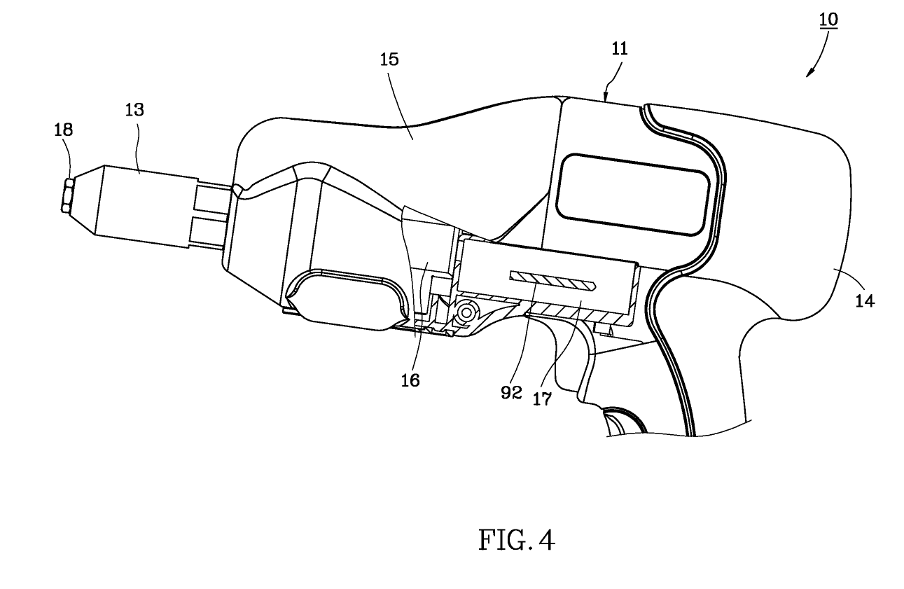

Referring to FIGS. 1-4, a riveting tool 10 with a rivet rod expelling function in accordance with a first embodiment of the present invention is shown comprising a tool body 20. The tool body 20 comprises a base 11 and a grip 12 extended from the base 11. The base 11 has a front side 13, a rear side 14 and a peripheral wall 15 disposed between the front side 13 and the rear side 14. The grip 12 is formed integrally with and extends obliquely from the peripheral wall 15. The base 11 defines therein a passage 16. The peripheral wall 15 of the base 11 has an opening 17 in communication with the passage 16. The opening 17 is formed between the passage 16 and the grip 12 at one lateral side of the base 11 at a location near the grip 12.

The front side 13 of the base 11 has a rivet hole 18 in communication with the passage 16. A riveting mechanism (not shown) is provided inside the base 11 between the rivet inlet 18 and the passage 16. The riveting tool 10 further comprises an electrically connected driving device and battery set 21. The driving device and battery set 21 drives the riveting mechanism to pull a rivet 91 in the rivet inlet 18, causing the rivet rod 92 of the rivet 91 to be moved through the passage 16 into the opening 17.

When the riveting mechanism pulled apart the rivet rod 92 of the rivet 91, the broken rivet rod 92 is moved into the opening 17. At this time, the user can slightly bias the hand that holds the grip 12, forcing the broken rivet rod 92 to fall out of the base 11 through the opening 17.

As stated above, the opening 17 is located on one lateral side of the tool body 20 adjacent to the grip 12. Thus, the user can expel the broken rivet rod 92 out of the tool body 20 simply by biasing the grip 12 slightly sideways. When compared to prior art riveting tools, the riveting tool in accordance with the present invention has the advantages of ease of operation and simple structure. The riveting mechanism and other related components of the riveting tool in accordance with the present invention have relatively longer service life.

By means of the aforesaid composition of the present invention, the riveting tool facilitates the user to expel the broken rivet rod.

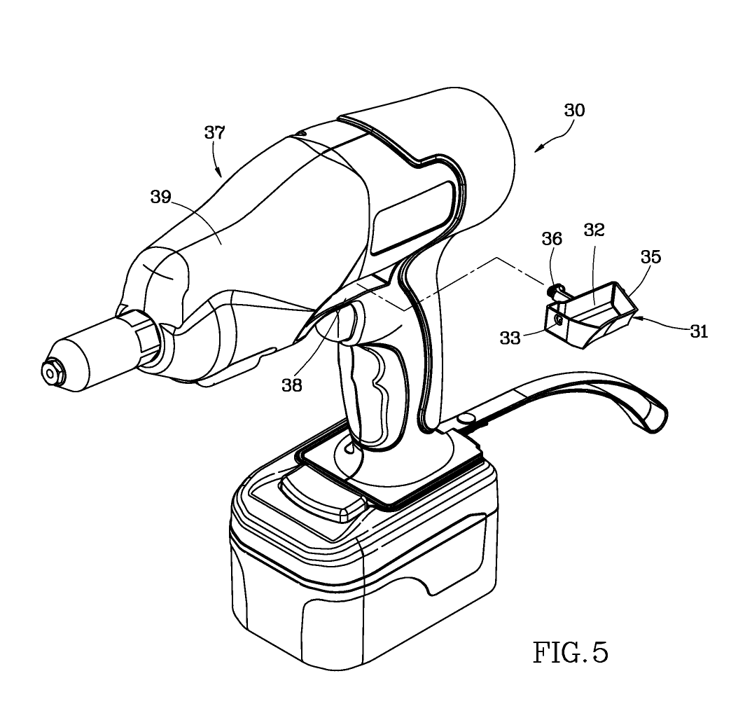

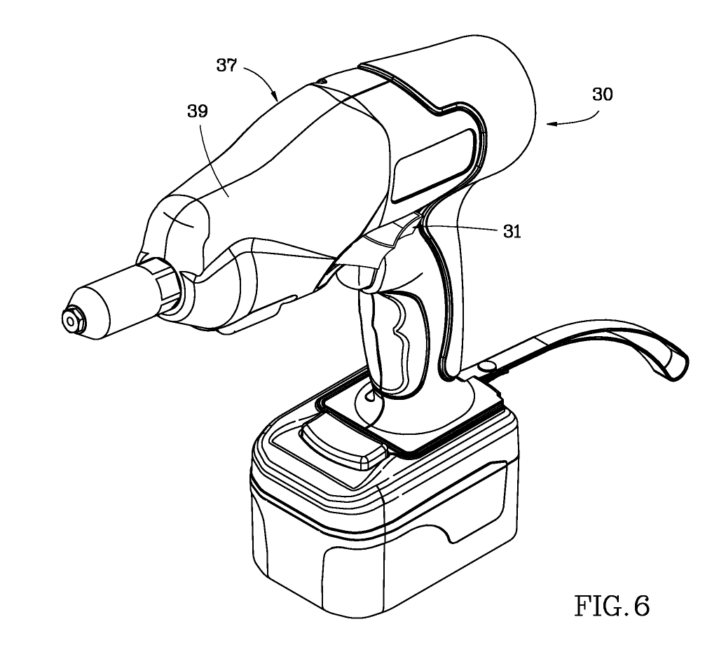

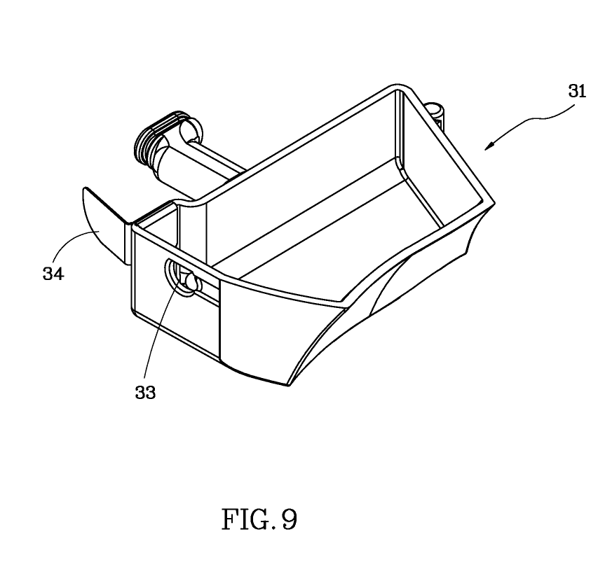

FIGS. 5 and 6 show a riveting tool with a rivet rod expelling function 30 in accordance with a second embodiment of the present invention. This second embodiment is substantially similar to the aforesaid first embodiment with the exception of an added rivet rod collector 31. The rivet rod collector 31 is a hollow open shell having a rivet rod collecting open space 32 surrounded by the upright front wall, upright rear wall and two opposite upright lateral walls thereof, a through hole 33 located on one upright lateral wall in communication with the rivet rod collecting open space 32, a coupling portion 35 located on the other upright lateral wall and a push rod 36 perpendicularly outwardly extended from the upright front wall thereof. The coupling portion 35 of the rivet rod collector 31 is pivotally coupled to an inner side of the opening 38 of the base 37 such that the rivet rod collector 31 can be biased between a first position and a second position. When in the first position, the rivet rod collector 31 is received inside the base 37 and the rivet rod collecting open space 32 is kept in communication with the passage 16 through the through hole 33. When the rivet rod of the inserted rivet is pulled apart, the broken rivet rod will fall to the inside of the rivet rod collecting open space 32 of the rivet rod collector 31. When the user pushes the push rod 36, the rivet rod collector 31 is biased from the first position to the second position where the rivet rod collector 31 protrudes out of the peripheral wall 39 of the base 37, i.e., the rivet rod collecting open space 32 is opened to let the collected rivet rod fall out of the riveting tool 30. By means of the design of the rivet rod collector 31, the user can conveniently expel broken rivet rods and can also use the rivet rod collector 31 to collect broken rivet rods. Thus, the user can pour out collected broken rivet rods after a continuous series of riveting and rivet rod expelling operations. Therefore, the invention facilitates the work. Further, as shown in FIG. 9, the rivet rod collector 31 can be made having a stop plate 34 extended from the upright front wall adjacent to the through hole 33. When the rivet rod collector 31 is biased out of the base 37, the stop plate 34 blocks the gap between the passage 16 and the opening 17 temporarily. If the rivet rod collector 31 is not accurately moved to the first position where the through hole 33 is not in fully communication with the passage 16, the stop plate 37 stops the broken rivet rod in the passage 16, maintaining normal functioning of the rivet rod expelling function.

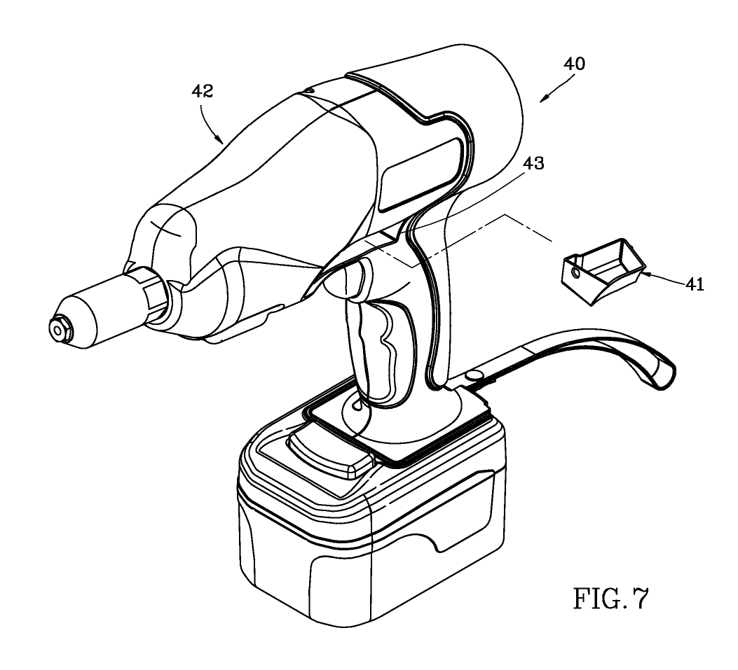

FIG. 7 shows a riveting tool with a rivet rod expelling function 40 in accordance with a third embodiment of the present invention. Similar to the aforesaid second embodiment, this third embodiment is equipped with a rivet rod collector 41. The rivet rod collector 41 can be transversely straightly inserted into the opening 43 of the base 42 and then moved in and out of the base 42 like a drawer.

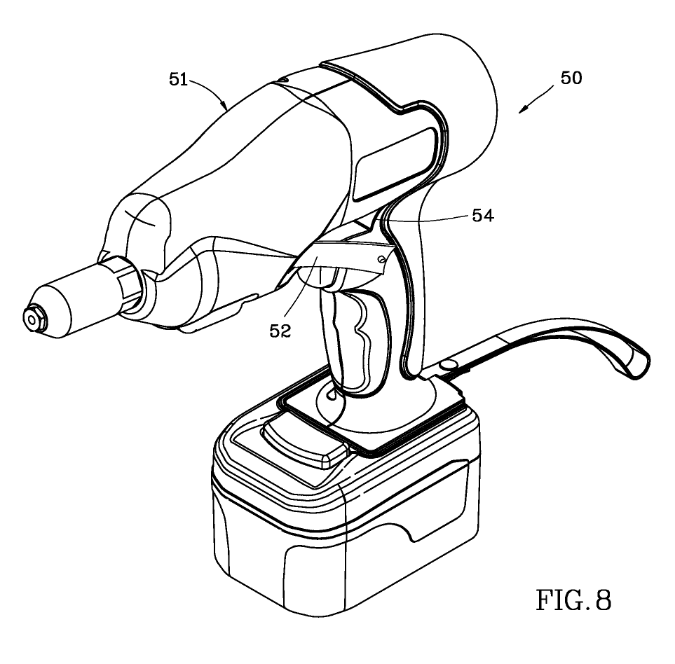

FIG. 8 shows a riveting tool with a rivet rod expelling function 50 in accordance with a fourth embodiment of the present invention. According to this fourth embodiment, the base 51 is provided with a cover plate 52. The cover plate 52 is movable relative to the base 51 to close or open the opening 54. Thus, the riveting operation can be continuously performed and the broken rivet rods can be collected inside the opening 54 of the base 51 when the cover plate 52 is kept in the close position. When the user opens the cover plate 52 from the opening 54, the collected broken rivet rods can be poured out of the riveting tool 50.

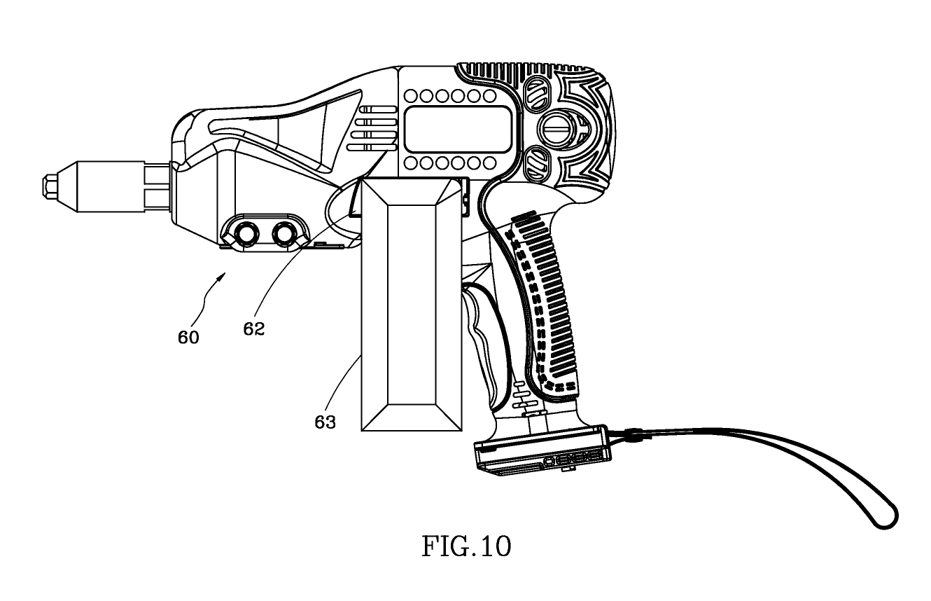

FIG. 10 shows a riveting tool with a rivet rod expelling function 60 in accordance with a fifth embodiment of the present invention. According to this fifth embodiment, a rivet rod collection bag 63 is directly attached to the opening 62 of the base 61 to collect a bit amount of broken rivet rods. This design achieves the same rivet rod expelling effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A riveting tool, comprising a tool body, said tool body comprising a base and a grip extended from said base, said base comprising an internal rivet passage and a peripheral opening in communication with said internal rivet passage, said peripheral opening being located on a location between said passage and said grip.

2. The riveting tool as claimed in claim 1, wherein said opening of said base is disposed adjacent to said grip.

3. The riveting tool as claimed in claim 1, wherein said base has a front side, a rear side and a peripheral wall connected between said front side and said rear side;
said grip is formed integral with and extends obliquely from said peripheral wall; said opening is located on said peripheral wall adjacent to said grip.

4. The riveting tool as claimed in claim 1, further comprising a rivet rod collector, said rivet rod collector defining therein a rivet rod collection space for collecting broken rivet rods, said rivet rod collector being pivotally connected to said base corresponding to said opening and biasable relative to said base between a first position where said rivet rod collection space is kept in communication with said passage and a second position where said rivet rod collection space is disposed outside said base to discharge collected rivet rods.

5. The riveting tool as claimed in claim 1, further comprising a rivet rod collector detachably mounted in said opening of said base, said rivet rod collector defining therein a rivet rod collection space for collecting rivet rods, said rivet rod collection space being kept in communication with said passage when said rivet rod collector is mounted in said opening of said base.

6. The riveting tool as claimed in claim 5, wherein said rivet rod collector has a stop plate extended from the periphery thereof and adapted to block the gap between said opening and said passage when said rivet rod collector is biased relative to said base.

7. The riveting tool as claimed in claim 1, further comprising a cover plate detachably attachable to said base to close or open said opening.

8. The riveting tool as claimed in claim 1, wherein said base comprises a rivet inlet disposed in communication with said passage for the insertion of a rivet, and a riveting mechanism mounted therein between said rivet inlet and said passage for pulling apart a rivet rod of a rivet been inserted into said rivet inlet to let the broken rivet rod move through said passage to said opening.

9. The riveting tool as claimed in claim 8, further comprising an electrically connected driving device and battery set mounted in said tool body and coupled to said riveting mechanism for driving said riveting mechanism to pull a rivet.

10. The riveting tool as claimed in claim 1, further comprising a rivet rod collection bag attached to said opening of said base for collecting rivet rods.
